(19) United States
(12) Patent Application Publication
(10) Pub. No.: US 2003/0004754 A1
(43) Pub. Date: Jan. 2, 2003

(54) Hipaa compliance systems and methods

(75) Inventor: Ronald L. Krutz, Alexandria, VA (US)

Correspondence Address: GREENBERG-TRAURIG, 1750 TYSONS BOULEVARD, 12TH FLOOR, MCLEAN, VA, 22102, US

(73) Assignee: Corbett Technologies, Inc., Alexandria, VA

(21) Appl. No.: 10/117,344

(22) Filed: Apr. 8, 2002

Related U.S. Application Data
(60) Provisional application No. 60/281,787, filed on Apr. 6, 2001.

(51) Int. Cl. G06F 17/60

(52) U.S. Cl. 705/2

(57) ABSTRACT

A Compatibility Maturity Model assessment methodology (HIPAA-CMM) for evaluating compliance with the Health Insurance Portability and Accountability Act (“HIPAA”). The model is based on a proven and recognized CMM framework developed initially for measuring the quality and maturity level of an organization's software development processes and that has been extended to Systems Engineering and Systems Security Engineering. Unlike existing CMMs, HIPAA-CMM achieves the granularity and coverage necessary to provide a formal, repeatable, and consistent methodology to assess an organization's HIPAA compliance. This approach identifies areas of strong and marginal compliance, as well as those areas which are not in compliance with HIPAA, and provides a consistent basis for defining remediation means. Inherently, the HIPAA-CMM also serves as a tool for implementing continuous improvement and evaluating the effectiveness of the improvement measures.

This application claims priority to U.S. Patent Application Serial No. 60/281,787 entitled “HIPAA Compliance Systems and Methods” filed Apr. 6, 2001, the teachings of which are incorporated herein by reference in their entirety.

### FIELD OF THE INVENTION

The present invention relates to the field of process improvements, and specifically provides a method through which information security processes may be evaluated and improved.

### BACKGROUND OF THE INVENTION

The basic premise of process improvement is that the quality of goods and services produced is a direct function of the quality of the associated development and maintenance processes. The Carnegie Mellon Software Engineering Institute (SEI) has developed an approach to process improvement called the IDEAL model, which is described in the document entitled “Systems Engineering Compatibility Model, Version 1.0”, published by SEI and available via the Internet at http://www.sei.cmu.edu/pub/documents/94.reports/pdf/hb04.94.pdf, the teachings of which are incorporated herein by reference in their entirety. IDEAL stands for Initiating, Diagnosing, Establishing, Acting and Learning.

The goal of the IDEAL model is to establish a continuous cycle of evaluating an organization's current processes, making improvements, and repeating this process. The high level steps are described below and are illustrated in FIG. 1.

I Initiating Laying the groundwork for a successful improvement effort.

D Diagnosing Determining where you are relative to where you want to be.

E Establishing Planning the specifics of how you will reach your destination.

A Acting Doing the work according to the plan.

L Learning Learning from the experience and improving your ability.

Each of the five phases of the IDEAL approach is made up of several activities.

The Initiating Phase—Embarking upon a security engineering process improvement effort should be handled in the same manner in which all new projects within an organization are approached. One must become familiar with the project's objectives and means for their accomplishment, develop a business case for the implementation, gain the approval and confidence of management, and develop a method for the project's implementation.

Effective and continuous support of the process improvement effort throughout its lifetime is essential for successful process improvement. Such support, or “sponsorship”, involves not only making available the financial resources necessary to continue the process but also personal attention from management to the project. After the relationship between the proposed effort and business goals has been established and key sponsors have given their commitment, a mechanism for the project's implementation must be established.

The Diagnosing Phase—To perform process development/improvement activities, it is imperative that an understanding of an organization's current and desired future state of process maturity be established. These parameters form the basis of the organization's process improvement action plan.

Performing a gap analysis emphasizes the differences between the current and desired states of an organization's processes and reveals additional information or findings about an organization. Grouped according to area of interest, these findings form the basis of recommendations for how to improve an organization.

The Establishing Phase—In this phase a detailed plan of action based on the goals of the effort and the recommendations developed during the Diagnosing Phase is created. In addition, the plan must take into consideration any possible constraints, such as resource limitations, which might limit the scope of the improvement effort. Priorities, along with specific outputs and responsibilities, are also put forth in the plan.

Time constraints, available resources, organizational priorities, and other factors may not allow for all of the goals to be realized or recommendations to be implemented during a single instance of the process improvement lifecycle. Therefore, the organization must establish priorities for its improvement effort.

As a result of the organization characterization defined in the Diagnosing Phase and priorities associated therewith, the scope of the process improvement effort may be different from that developed in the Initiating Phase. The Establishing Phase requires that any redefined objectives and recommendations be mapped to potential strategies for accomplishing desired outcomes.

At this point, all of the data, approaches, recommendations, and priorities are brought together in the form of a detailed action plan. Included in the plan are the allocation of responsibilities, resources, specific tasks, and tracking tools to be used, as well as any deadlines and milestones. The plan should also include contingency plans and coping strategies for any unforeseen problems.

The Acting Phase—This is the implementation phase and requires the greatest level of effort of all the phases both in terms of resources and time. Achieving the organization's goals may require multiple parallel cycles within the Acting Phase to address all desired improvements and priorities.

Solutions, or improvement steps, for each problem area are developed based on available information on the issue and resources for implementation. At this stage, the solutions are ‘best guess’ efforts of a technical working group.

The first step in designing processes that will meet the business needs of an enterprise is to understand the business, product, and organizational context that will be present when the process is being implemented. Some questions that need to be answered before process design include:

How is security engineering practiced within the organization?

What life cycle will be used as a framework for this process?

How is the organization structured to support projects?

How are support functions handled (e.g., by the project or the organization)?

What are the management and practitioner roles used in this organization?

How critical are these processes to organizational success?

Because first attempts at generating solutions rarely succeed, all solutions must be tested before they are implemented across an organization. How an organization chooses to test its solutions is dependent upon the nature of the area of interest, the proposed solution, and the resources of the organization.

Using information collected during testing, potential solutions should be modified to reflect new knowledge about the solution. The importance of the processes under focus as well as the complexity of the proposed improvements will dictate the degree of testing and refinement proposed solutions must undergo before being considered acceptable for implementation throughout an organization.

Once a proposed improved process has been accepted it must be implemented beyond the test group. Depending upon the nature and degree to which a process is being improved, the implementation stage may require significant time and resources. Implementation may occur in a variety of ways depending upon the organization's goals.

The Learning Phase—The Learning Phase is both the final stage of the initial process improvement cycle and the initial phase of the next process improvement effort. Here the entire process improvement effort is evaluated in terms of goal realization and how future improvements can be instituted more efficiently. This phase is only as constructive as the detail of records kept throughout the process and the ability of participants to make recommendations.

Determining the success of process improvement requires analyzing the final results in light of established goals and objectives. It also requires evaluating the efficiency of the effort and determining where further enhancements to the process are required. These lessons learned are then collected, summarized and documented.

Based on an analysis of the improvement effort itself, the lessons learned are translated into recommendations for subsequent improvement efforts. These recommendations should be promulgated outside those guiding the improvement effort for incorporation in this and other improvement efforts.

According to the IDEAL method, the following basic principles of process change are necessary to implement a successful process improvement activity:

Sponsorship of major changes by Senior Management

Focusing on fixing the process, not assigning the blame

Understanding current processes first

Realizing that change is continuous

Accepting that improvement requires investment

Retaining improvement requires periodic reinforcement.

In 1986, in collaboration with Mitre Corporation, the SEI developed a methodology for measuring the maturity of software development processes. This methodology was formalized into the creation of Capability Maturity Models (CMM) of Software. Although originally designed for the analysis and improvement of software and software development processes, the CMM methodology can be used to analyze almost any process. A CMM generally describes the stages through which development processes progress as they are defined, implemented and improved. In addition, a CMM defines a process's capability as the quantifiable range of expected results that can be achieved by following a process.

Because of its flexibility, the CMM methodology has been applied to many environments as the framework for implementing process improvements. For example, the “Systems Security Engineering Capability Maturity Model SSE-CMM Model Description Document Version 2.0”, published Apr. 1, 1999 by the Systems Security Engineering Capability Maturity Model (SSE-CMM) Project and available via the Internet at http://www.sse-cmm.org, referred to herein as simply SSE-CMM, applies the CMM methodology to systems security engineering, and the teachings thereof are incorporated herein by reference in their entirety. In the SSE-CMM, the authors state:

“The model provides a guide for selecting process improvement strategies by determining the current capabilities of specific processes and identifying the issues most critical to quality and process improvement within a particular domain. A CMM may take the form of a reference model to be used as a guide for developing and improving a mature and defined process.”

TABLE 1
Table 1 contrasts the SSE-CMM with other related efforts. Note that the SSE-
CMM is the only known approach focused on information system security engineering.

| Effort | Goal | Approach | Scope |
|---|---|---|---|
| SSE-CMM | Define, improve, and assess | Continuous security engineering | Security |
| | security engineering capability | maturity model and appraisal method | engineering |
| | | organizations | |
| SE-CMM | Improve system or product | Continuous maturity model of systems | Systems |
| | engineering process | engineering practices and appraisal | engineering |
| | | method | organizations |
| SEI CMM for | Improve the management of | Staged maturity model of software | Software |
| Software | software development | engineering and management practices | engineering |
| | | | organizations |
| Trusted CMM | Improve the process of high | Staged maturity model of software | High integri- |
| | integrity software development | engineering and management practices | ty software |
| | and its environment | including security | organizations |
| CMMI | Combine existing process | Sort, combine, and arrange process | Engineering |
| | improvement models into a | improvement building blocks to form | organizations |
| | single architectural framework. | tailored models | |
| System | Define, improve, and assess | Continuous systems engineering | System |
| Engineering | systems engineering capability | maturity model and appraisal method | engineering |
| CMM | | | organizations |
| (EIA731) | | | |
| Common | Improve security by enabling | Set of functional and assurance | Information |
| Criteria | reusable protection profiles for | requirements for security, along with an | technology |
| | classes of technology | evaluation process | |
| CISSP | Make security professional a | Security body of knowledge and | Security |
| | recognized discipline | certification tests for security profession | practitioners |
| Assurance | Improve security assurance by | Structured approach for creating | Security |
| Frameworks | enabling a broad range of | assurance arguments and efficiently | engineering |
| | evidence | producing evidence | organizations |
| ISO 9001 | Improve organizational quality | Specific requirements for quality | Service |
| | management | management practices | organizations |
| ISO 15504 | Software process improvement | Software process improvement model | Software |
| | and assessment | and appraisal methodology | engineering |
| | | | organizations |
| ISO 13335 | Improvement of management | Guidance on process used to achieve | Security |
| | of information technology | and maintain appropriate levels security | engineering |
| | security | for information and services | organizations |

The SSE-CMM is based on the SE-CMM developed by SEI. The eleven Project and Organizational Process Areas (PAs) of the SSE-CMM come directly from the SE-CMM. These areas are:

PA12—Ensure Quality

PA13—Manage Configuration

PA14—Manage Project Risk

PA15—Monitor and Control Technical Effort

PA16—Plan Technical Effort

PA17—Define Organization's Systems Engineering Process

PA18—Improve Organization's Systems Engineering Process

PA19—Manage Product Line Evolution

PA20—Manage Systems Engineering Support Environment

PA21—Provide Ongoing Skills and Knowledge

PA22—Coordinate with Suppliers

SE-CMM describes essential elements of an organization's systems engineering process that must exist to ensure good systems engineering. It also provides a reference to compare existing systems engineering practices against essential systems engineering elements described in the model. SE-CMM is based on systems engineering definitions in which scientific and engineering efforts are selectively applied to:

transform an operational need into a system configuration description which best satisfies operational needs according to effectiveness measures;

integrate related technical parameters and ensure compatibility of all physical, functional, and technical program interfaces in a manner which optimizes the total system definition and design; and,

integrate the efforts of all engineering disciplines and specialties into the total engineering effort.

Similarly, the SE-CMM defines a system as:

an integrated composite of people, products, and processes that provide a capability to satisfy a need or objective;

an assembly of things or parts forming a complex or unitary whole; a collection of components organized to accomplish a specific function or set of functions; and

an interacting combination of elements, viewed in relation to function.

SSE-CMM takes a process-based approach to information systems security and is based on SE-CMM. SE-CMM methodology and metrics are duplicated in SSE-CMM in that SSE-CMM provides a reference to compare existing systems security engineering best practices against essential systems security engineering elements described in the model.

SSE-CMM defines two dimensions that are used to measure the ability of an organization to perform specific activities: domain and capability. The domain dimension consists of all practices that collectively define security engineering. These practices are referred to as “base practices” (BPs). The capability dimension represents practices that indicate process management and institutionalization capability. These practices are called “generic practices” (GPs) as they apply across a wide range of domains. GPs represent activities that should be performed as part of performing BPs. The relationship between BPs and GPs is given in FIG. 2, which illustrates evaluation of resource allocations to support BPs of identifying system security vulnerabilities.

For the domain dimension, SSE-CMM specifies eleven technical security engineering PAs and eleven organizational and project-related PAs, each comprised of BPs. BPs are mandatory characteristics that must exist within an implemented security engineering process before an organization can claim satisfaction in a given PA. The twenty-two PAs and their corresponding BPs incorporate systems security engineering best practices. The PAs are:

Technical

PA01 Administer Security Controls

PA02 Assess Impact

PA03 Assess Security Risk

PA04 Assess Threat

PA05 Assess Vulnerability

PA06 Build Assurance Argument

PA07 Coordinate Security

PA08 Monitor Security Posture

PA09 Provide Security Input

PA10 Specify Security Needs

PA11 Verify and Validate Security

Project and Organizational Practices

PA12—Ensure Quality

PA13—Manage Configuration

PA14—Manage Project Risk

PA15—Monitor and Control Technical Effort

PA16—Plan Technical Effort

PA17—Define Organization's Systems Engineering Process

PA18—Improve Organization's Systems Engineering Process

PA19—Manage Product Line Evolution

PA20—Manage Systems Engineering Support Environment

PA21—Provide Ongoing Skills and Knowledge

PA22—Coordinate with Suppliers

The capability dimension incorporates process management and institutionalization practices, referred to as GPs. These GPs apply to all PAs and serve to measure the capability of an organization to perform the PAs. The GPs are ordered in degrees of maturity and are grouped to form and distinguish among five levels of security engineering maturity. The attributes of these five levels are:

Level 1

1.1 Base Practices are Performed

Level 2

2.1 Planning Performance

2.2 Disciplined Performance

2.3 Verifying Performance

2.4 Tracking Performance

Level 3

3.1 Defining a Standard Process

3.2 Perform the Defined Process

3.3 Coordinate the Process

Level 4

4.1 Establishing Measurable Quality Goals

4.2 Objectively Managing Performance

Level 5

5.1 Improving Organizational Capability

5.2 Improving Process Effectiveness

The corresponding general descriptions of the five levels are given as follows:

Level 1, “Performed Informally”, focuses on whether an organization or project performs a process that incorporates the BPs. A statement characterizing this level would be “you have to do it before you can manage it.”

Level 2, “Planned and Tracked”, focuses on project-level definition, planning, and performance issues. A statement characterizing this level would be “understand what's happening on the project before defining organization-wide processes.”

Level 3, “Well Defined”, focuses on disciplined tailoring from defined processes at the organization level. A statement characterizing this level would be “use the best of what you've learned from your projects to create organization-wide processes.”

Level 4, “Quantitatively Controlled”, focuses on measurements being tied to the business goals of the organization. Although it is essential to begin collecting and using basic project measures early, measurement and use of data is not expected organization-wide until the higher levels have been achieved. Statements characterizing this level would be “you can't measure it until you know what ‘it’ is” and “managing with measurement is only meaningful when you're measuring the right things.”

Level 5, “Continuously Improving” gains leverage from all the management practice improvements seen in the earlier levels, then emphasizes the cultural shifts that will sustain the gains made. A statement characterizing this level would be “a culture of continuous improvement requires a foundation of sound management practice, defined processes, and measurable goals.”

The process evaluation techniques set forth above have been applied in the area of security software development for several years. However, Congress recently enacted legislation which has created a new avenue for applying these process evaluation techniques.

The U.S. Kennedy-Kassabaum Health Insurance Portability and Accountability Act (HIPAA-Public Law 104-191), effective date Aug. 21, 1996, addresses the issues of health care privacy and plan portability in the United States. With respect to privacy, the Act states “Not later than the date that is 12 months after the date of the enactment of this Act, the Secretary of Health and Human Services shall submit . . . detailed recommendations on standards with respect to the privacy of individually identifiable health information.” The Act further states that “the recommendations . . . shall address at least the following:

1. The rights that an individual who is a subject of individually identifiable health information should have.

2. The procedures that should be established for the exercise of such rights.

3. The uses and disclosures of such information that should be authorized or required.”

The Act provides that if the legislation governing standards with respect to the privacy of individually identifiable health information is not enacted by “the date that is 36 months after the enactment of this Act, the Secretary of Health and Human Services shall promulgate final regulations containing such standards not later than the date that is 42 months after the date of the enactment of this Act.” Congress failed to act by that date and, therefore, the Secretary of Health and Human Services was required to issue privacy regulations no later than Feb. 21, 2000. This date was not met, but the regulations were announced in December of 2000 and included the following:

Coverage extends to medical records of all forms, not only those in electronic form. This coverage includes oral and paper communications that did not exist in electronic form.

Patient consent is required for routine health record disclosures.

Disclosure of full medical records is allowed for purposes of treatment to providers.

Unauthorized use of medical records for employment purposes is prohibited.

Final privacy regulations have been promulgated, however changes have been proposed thereto. In addition, the Security Rule, Electronic Signatures and Identifiers standards associated therewith are still in draft form. However, the privacy regulations state the following in reference to information system security requirements:

“c) (1) Standard: safeguards. A covered entity must have in place appropriate administrative, technical, and physical safeguards to protect the privacy of protected health information.

(2) Implementation specification: safeguards. A covered entity must reasonably safeguard protected health information from any intentional or unintentional use or disclosure that is in violation of the standards, implementation specifications or other requirements of this subpart.”

At the present state of the regulations, HIPAA provides the following penalties for violations:

General penalty for failure to comply—each violation $100; maximum for all violations of an identical requirement may not exceed $25,000

Wrongful disclosure of identifiable health information—$50,000, imprisonment of not more than one year, or both

Wrongful disclosure of identifiable health information under false pretenses—$100,000, imprisonment of not more than five years, or both

Offense with intent to sell information—$250,000, imprisonment of not more than ten years, or both

### SUMMARY OF THE INVENTION

Addressing the Health Insurance Portability and Accountability Act (HIPAA) health information standards in an effective manner requires a sound, structured approach. The method of compliance with HIPAA privacy regulations and pending Security Rule, Electronic Signatures and Identifiers standards should provide proper and complete coverage of the requirements of the law and support metrics for evaluating implementation effectiveness.

The major issue relative to meeting HIPAA information security requirements at this time is that there is no standard process in place to determine HIPAA compliance. This situation becomes more complicated when institutions are evaluated according to different criteria and methodologies. What is needed is a standard methodology and evaluation model that is based on proven, valid techniques that are recognized by the information security community. The present invention is a HIPAA-Capability Maturity Model (HIPAA-CMM) based on such techniques. The model is based on a proven and recognized CMM framework developed initially for measuring the quality and maturity level of an organization's software development processes and that has been extended to Systems Engineering and Systems Security Engineering.

While the Security Rule, Electronic Signatures and Identifiers regulations have yet to be finalized and are subject to amendment, the privacy regulation already provides that “[a] covered entity must have in place appropriate administrative, technical and physical safeguards to protect the privacy of protected health information.” A review of the current draft regulation on security standards reveals that it codifies information system security best practices that are generally accepted in the commercial government arenas. To comply with the Act and the privacy regulation's requirement for “appropriate administrative, technical and physical safeguards,” covered entities will have to demonstrate due diligence in implementing generally accepted information system security best practices.

HIPAA-CMM is a standard framework for evaluating and assuring HIPAA compliance. The Process Areas (PAs) selected for HIPAA-CMM are based on generally accepted best practices of systems security engineering. A PA is a defined set of related security engineering process characteristics which, when performed collectively, can achieve a defined purpose. Thus, HIPAA-CMM will not only measure compliance with current HIPAA requirements, but also with standards likely to be included in final Security Rules and Electronic Signatures and Identifiers regulations when issued.

HIPAA-CMM has its roots in the Systems Security Engineering Capability Maturity Model (SSE-CMM), however HIPAA-CMM represents an improvement over SSE-CMM. The SSE-CMM PAs incorporate technical, organizational, and project best practices of systems security engineering. As such, they provide a process-based common thread that encompasses most security-related evaluation criteria and security guidance documents. HIPAA-CMM incorporates a subset of the twenty-two SSE-CMM PAs to address HIPAA privacy and information security requirements by providing coverage and granularity as required by HIPAA regulations that are not addressed by the SSE-CMM. The present invention achieves these goals through development of additional PAs.

These PAs are HIPAA-specific PAs (HPAs) and serve to customize the model for the HIPAA application. The HPAs are based on the final HIPAA Privacy Rule and the HIPAA Transaction Code Set Standards. Although the Security Rule, Electronic Signatures and Identifiers has not been promulgated as of the time of filing, corresponding requirements have been developed based on proposed rules and generally accepted best security practices. As a result, HIPAA-CMM is designed as a basis for providing full evaluation coverage necessary to address all HIPAA information security compliance requirements.

A catalyst for the present invention was an initial investigation of relationships between SSE-CMM and other federal information security compliance standards. Questions asked during this investigation included:

1. “How can the SSE-CMM assist in supporting the use of federal security standards and guidelines?”; and

2. “How can the SSE-CMM be used to gather evidence of compliance?”

In the past, SSE-CMM PA mappings to federal security standards and guidelines have been shown to be feasible and valuable in providing evidence for evaluation of assurance mechanisms. In all such mappings, SSE-CMM is viewed as complementary to associated evaluation criteria and provides a structured basis for evidence gathering and assurance. However, HIPAA regulations require an enterprise view of an organization's privacy and security processes and procedures that is not implemented by Information Technology/Information Security (IT/IS) evaluation mechanisms or fully covered by SSE-CMM. Thus, there is a need for supplemental PAs to meet proposed HIPAA information security legislative requirements. These supplemental PAs and selected SSE-CMM PAs comprise HIPAA-CMM.

SSE-CMM mappings investigated as part of HIPAA-CMM development were those involved with Common Criteria Assurance Requirements, Defense Information Technology Security Certification and Accreditation Process (DITSCAP) and the Trusted Computer System Evaluation Criteria (TCSEC). The mappings also apply to the National Information Assurance Certification and Accreditation Process (NIACAP) because NIACAP is an extension of DITSCAP for non-defense Government organizations. NIACAP and DITSCAP were developed for independent evaluation of Government IT/IS and are very effective in performing that function. Also, a version of the NIACAP, the Commercial INFOSEC Analysis Process (CIAP) is under development for evaluation of critical commercial systems.

Other SSE-CMM mappings have been proposed, including to ISO/IEC 13335 Information Technology—Security Techniques Guidelines for the Management of IT Security (GMITS)—Part 2; the NIST Handbook; BS 7799; and the Canadian Handbook on Information Technology Security MG-9.

The mapping of process-based mechanisms (SSE-CMM) to assurance-based mechanisms (Common Criteria, DITSCAP, TCSEC) has been addressed by Ferraiolo, et. al. in their December, 1997 paper entitled “Final Report Contract Number 50-DKNB-7-90099, Process-Based Assurance Product Suite” and their 1999 paper, entitled “Building a Case for Assurance from Process”, the teachings of both of which are incorporated herein by reference in their entirety. Ferraiolo, et. al's analysis produced the following general conclusions:

Although there is a significant overlap between SSE-CMM PAs and the assurance-based activities, there is not always a complete one-to-one mapping

SSE-CMM may not provide the level of granularity required to directly address all specific assurance requirements

SSE-CMM can be used to develop assurance arguments and product assurance evidence if applied with appropriate guidance

In most cases, the PAs of the SSE-CMM correspond well with traditional assurance processes

The processes defined in the SSE-CMM are considered to contribute to the development of assurance arguments by integrators, product developers, evaluators and manufacturers.

With the appropriate guidance, tailoring and evidence gathering, it was demonstrated that the results of an SSE-CMM assessment could support important aspects of traditional assurance-based mechanisms

The SSE-CMM can be viewed as a common thread that logically links traditional assurance methods.

In a similar vein, Hopkinson has proposed mappings to ISO/IEC 13335 Information Technology—Security Techniques -Guidelines for the Management of IT Security (GMITS)—Part 2; the NIST Handbook; BS 7799; and the Canadian Handbook on Information Technology Security MG-9.

In the referenced mappings and HIPAA mappings developed as part of the present invention, SSE-CMM is complementary to associated evaluation criteria and provides a structured basis for evidence gathering and assurance. However, for specific assurance areas in HIPAA requiring more granularity than provided by the SSE-CMM, additional BPs must be applied.

As stated in Ferraiolo, et. al.'s 1999 article, “For the evaluators and certifiers, the SSE-CMM can provide direct evidence regarding process claims, as well as a uniform method to evaluate claims and evidence, thus contributing to the normalization of the evaluation/certification process-making the process more defined and repeatable and less intuitive. Ultimately, this direct benefit can be measured in terms of cost/schedule savings to evaluation and certification efforts.”

Therefore, HIPA-CMM was designed to provide assurance-based security mechanisms such as those required by HIPAA, including:

Ensuring the appropriate processes corresponding to the required assurance mechanisms are in place

Evidence gathering to support assurance claims

Ensuring complete coverage of required regulations or standards

Measuring the present information security posture

Evaluating effectiveness of remediation efforts

Ensuring repeatability of the appraisal process

Continuous improvement of the security processes

### BRIEF DESCRIPTION OF THE DRAWINGS

FIG. 1 is a block diagram illustrating the IDEAL process evaluation method of the prior art.

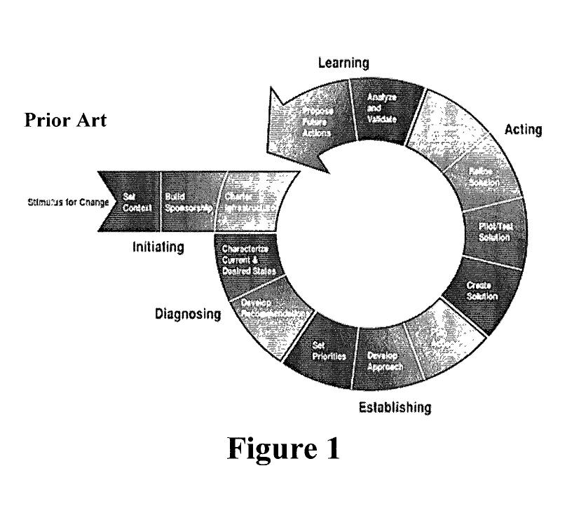

FIG. 2 is a block diagram of the Capability and Domain Dimensions of the SSE-CMM of the prior art.

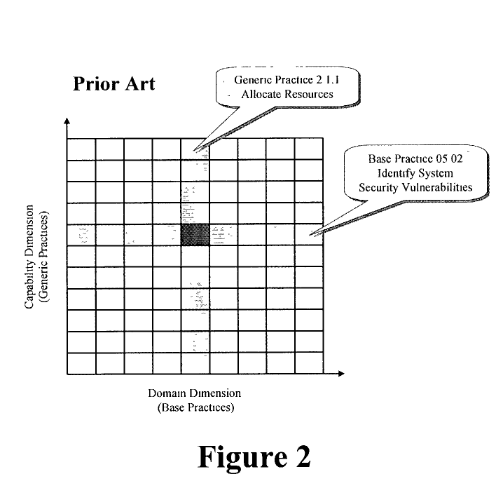

FIG. 3 is a process flow diagram illustrating the combining of complementary SSE-CMM and HPAs to develop the HIPAA-CMM and implement continuous process improvement.

### DETAILED DESCRIPTION OF THE PREFERRED EMBODIMENT

The HIPAA-CMM uses the GPs, capability levels, and a major subset of the PAs of SSE-CMM to evaluate HIPAA information security compliance. Remediation of the areas of weakness or noncompliance can then be addressed with confidence in a cost-effective manner.

Ideally, there would be a one-to-one mapping of all HIPAA information security requirements to SSE-CMM PAs. There are, in fact, such mappings but these mappings do not complete HIPAA compliance coverage based on the present state of HIPAA regulations and corresponding generally accepted best information security practices. Obviously, where HIPAA requirements are process-oriented, there is a better mapping to SSE-CMM PAs. Other HIPAA privacy regulations require more granularity and coverage of information security issues than provided by SSE-CMM PAs. These additional requirements are met using HIPAA specific PAs (HPAs) as defined herein.

In reviewing the HIPAA assurance requirements based on extant privacy regulations, the draft Security Rule, Electronic Signatures and Identifiers, and corresponding best information security practices, the following PAs from the SSE-CMM were selected. These PAs address a subset of the HIPAA requirements.

Technical

PA01 Administer Security Controls

PA02 Assess Impact

PA03 Assess Security Risk

PA04 Assess Threat

PA05 Assess Vulnerability

PA06 Build Assurance Argument

PA07 Coordinate Security

PA08 Monitor Security Posture

PA09 Provide Security Input

PA10 Specify Security Needs

PA11 Verify and Validate Security

Project and Organizational Practices

PA12—Ensure Quality

PA13—Manage Configuration

PA14—Manage Project Risk

PA15—Monitor and Control Technical Effort

PA17—Define Organization's Systems Engineering Process

PA21—Provide Ongoing Skills and Knowledge

PA22—Coordinate with Suppliers

To complete HIPAA compliance evaluation coverage, newly defined PAs tailored to the remaining HIPAA requirements are needed. These HIPAA Specific PAs, or HPAs, are developed and described below. The capability dimension of the SSE-CMM with its GPs will be used for the HIPAA-CMM model and its PAs.

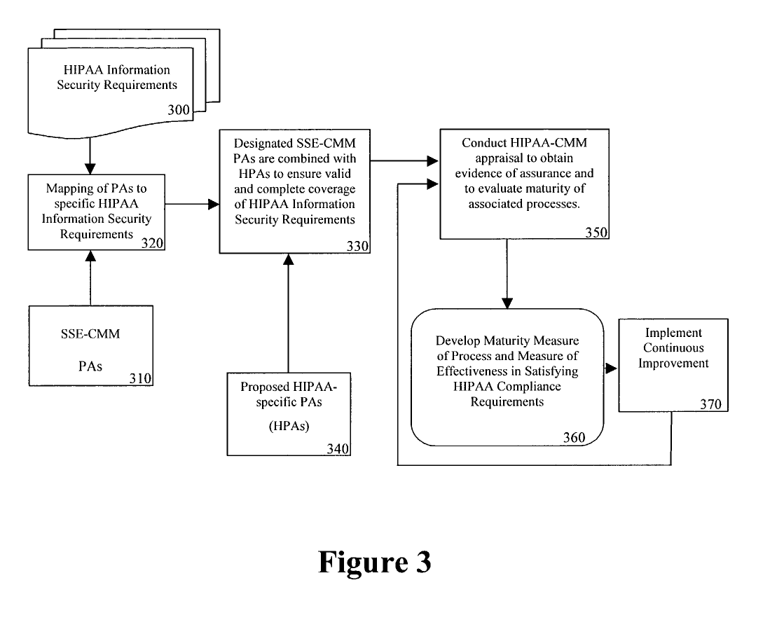

FIG. 3 illustrates a process by which complementary SSE-CMM and HPAs can be combined to develop a HIPAA-CMM and through which continuous process improvements can be implemented. Block 300 represents evaluating and organizing HIPAA information security requirements. Block 310 represent known SSE-CMM PAs. Block 340 represents HPAs as defined as part of the present invention or other, similar PAs. In Block 320, SSE-CMM PAs are mapped to specific HIPAA information security requirements. In Block 330, HPAs are combined with the SSE-CMM PA to HIPAA information security mappings to ensure valid and complete coverage of all HIPAA information security requirements.

In Block 350, HIPAA-CMM methods are employed to obtain information through which the maturity of the associated information security processes can be evaluated and the effectiveness of the processes can be assured. In Block 360, process maturity measures and HIPAA compliance requirement effectiveness are developed. In Block 370, corrections for any deficiencies identified in Block 360 from the data collected in Block 350 are implemented. Once such corrections are implemented, the impact of those corrections is analyzed by returning to Block 350. This process repeats in a periodic, iterative fashion to continually analyze the information security processes for compliance with HIPAA regulations. In addition, as new HIPAA requirements are promulgated or as existing requirements are changed or omitted, the process may be repeated beginning with Block 300.

The HPAs referenced above in conjunction with Block 340 are based on an analysis of HIPAA privacy regulations and the draft Security Rule, Electronic Signatures and Identifiers. The analysis revealed that the following five categories of HIPAA information security practice requirements could not be directly matched to SSE-CMM PAs:

Establishing and designating responsibility for ensuring that policies and procedures are followed relative to the release of individually identifiable patient healthcare information and establishing recourse for violations of these policies

Developing Disaster Recovery and Business Continuity Plans for all relevant networks and systems

Establishing Patient Health Care Information protection, validation and authentication through logical controls and protecting the confidentiality and data integrity of exchanged information with external entities

Establishing personnel information security policies and procedures

Addressing physical security requirements for information systems protection, including theft, fire and other hazards

Therefore, to complete the required coverage of the HIPAA compliance requirements, five PAs with corresponding BPs are needed. These HPAs incorporate the generally accepted best security engineering practices and are focused on the five identified HIPAA categories that could not be met by PAs of the SSE-CMM. The goals of the HPAs map to the HIPAA requirements and the BPs provide guidance on the specific actions to take to confirm that the goals are accomplished.

HPAs and related BPs implemented in the present invention include, but are not limited to:

HPA 01 Administer Patient Health Care Information Controls

HPA 02 Develop Disaster Recovery and Business Continuity Plans For All Relevant Networks And Systems

HPA 03 Establish Patient Health Care Information Security Controls

HPA 04 Evolve Personnel Information Security Policies and Procedures

HPA 05 Administer Physical Security Controls

HPA goals and BPs are detailed as follows:

HPA 01
Administer Patient Health Care Information Controls

| | |
|---|---|
| Goal 1 | Privacy officer is designated with required authority and responsibility. |
| Goal 2 | Limitations and guidance on the use and disclosure of individual medical information |
| | are stablished. |
| BP 01.01 | Designate a privacy officer who is responsible for enforcing policies and procedures |
| | and for the release of individually identifiable patient |
| | healthcare information. |
| BP 01.02 | Establish boundaries on use and release of individual medical records. |
| BP 01.03 | Establish recourse for violations of policies on use and release of individual medical records. |
| BP 01.04 | Provide patients with education on the privacy protection accorded to them. |
| BP 01.05 | Establish patient recourse and penalties for violations of security policies and procedures. |
| BP 01.06 | Ensure patient access to their individual medical records. |

HPA 02
Develop Disaster Recovery And Business Continuity Plans
For All Relevant Networks And Systems

| | |
|---|---|
| Goal 1 | Business Continuity Plan is developed and institutionalized. |
| Goal 2 | Disaster Recovery Plan is developed and institutionalized. |
| BP 02.01 | Establish Disaster Recovery Plan (Evaluate this process using supplementary information from |
| | SSE-CMM PAs 02, 03,04 and 05) |
| BP 02.02 | Establish Business Continuity Plan (Evaluate this process using supplementary information |
| | from SSE-CMM PAs 02, 03,04 and 05) |
| BP 02.03 | Institutionalize Disaster Recovery Plan |
| BP 02.04 | Institutionalize Business Continuity Plan |

HPA 03
Establish Patient Health Care Information Security Controls

| | |
|---|---|
| Goal 1 | Individual patient health care information is protected from unauthorized disclosure and |
| | modification. |
| Goal 2 | Authentication and nonrepudiation are established for external and internal patient health care |
| | information exchange. |
| BP 03.01 | Provide encryption and/or access control complying with the minimum requirements of |
| | applicable regulations to preserve |
| | privacy to preserve privacy of transmitted or stored patient health care |
| | information. |
| BP 03.02 | Provide identification and authentication mechanisms for access to the system and network. |
| BP 03.03 | Manage the destruction or alteration of sensitive information including logging |
| | of these activities. |
| BP 03.04 | Provide means for message non-repudiation and authentication. |
| BP 03.05 | Preserve the integrity of messages and provide means to detect modification of messages. |
| BP 03.06 | Provide log-on and log-off procedures to protect against unauthorized access to |
| | workstations and systems. |
| BP 03.07 | Protect the confidentiality and data integrity of exchanged information with partners through |
| | appropriate contracts. (Evaluate in conjunction with PA 22 of the SSE-CMM). |

HPA 04
Evolve Personnel Information Security Policies and Procedures

| | |
|---|---|
| Goal 1 | Personnel security controls are properly defined, administered and used. |
| BP 04.01 | Provide means and methods for processing terminated personnel to prevent violation |
| | of information security policies and procedures. |
| BP 04.02 | Manage personnel security issues, including clearance policies and procedures. |

HPA 05
Administer Physical Security Controls

| | |
|---|---|
| Goal 1 | Physical security controls are properly administered and used. |
| BP 05.01 | Establish policies and procedures for handling, storage and disposal of magnetic media and for |
| | object reuse. |
| BP 05.02 | Provide means and methods to protect computer systems and related buildings |
| | and equipment from fire and other hazards |
| BP 05.03 | Provide physical controls to liimt access to computer systems and facilities |
| | to authorized personnel |
| BP 05.04 | Provide for physical security of workstations and laptops. |

The HIPAA information security requirements based on the extant HIPAA regulations and draft standards have been developed using the generally accepted best information security practices. These requirements are best estimates at this time and are summarized in Tables 2 through 5.

The HIPAA security requirement mappings to SSE-CMM and the HPAs are also provided in Tables 2 through 5. The listed PAs ensure that the processes are in place to evaluate the application of the specific assurance mechanisms required by HIPAA legislation.

TABLE 2

| | SSE-CMM | |
|---|---|---|
| HIPAA Information Security and Privacy Requirements | Mapping | HPAs |
| Adopt written policies and procedures for the receipt, storage, | PA 01, 17, 22 | |
| processing and distribution of information. | | |
| Designate a Privacy Officer who is responsible for ensuring that the | PA 07, 10 | HPA 01 |
| policies and procedures are followed and for the release of individually | | |
| identifiable patient healthcare information. | | |
| Establish a security certification process that determines the degree to | PA 11,12 | |
| which the system, application or network meets security requirements. | | |
| Develop disaster recovery and business continuity plans for all relevant | PA 02, | HPA 02 |
| networks and systems. | 03, 04, 05, 06, 14 | |
| Train employees to ensure that they understand the new privacy | PA 21 | |
| protection procedures. | | |
| Establish contracts with all business partners protecting confidentiality | PA 22 | HPA 03 |
| and data integrity of exchanged information. | | |
| Implement personnel security, including clearance policies and | PA 01,09 | HPA 04 |
| procedures. | | |
| Develop and implement system auditing | PA 01, 06, | |
| policies and procedures. | 08, 12, 13, 15 | |
| Establish boundaries on use and release of individual medical records. | PA 01, 06, 10, 11 | HPA 01 |
| Ensure that patient consent is obtained pnor to the release of medical | PA 01, 10 | HPA 01 |
| information and that the consent is not coerced. | | |
| Provide patients with education on the privacy protection accorded to | PA 01, 10 | HPA 01 |
| them. | | |
| Ensure patients access to their medical records. | PA 01, 10 | HPA 01 |
| Establish patient recourse and penalties for violations of security | PA 01, 10, 11 | HPA 01 |
| policies and procedures. | | |
| Establish procedures for processing terminated personnel to prevent | PA 01, 21 | HPA 04 |
| violation of information security policies and procedures. | | |

TABLE 3

| | SSE-CMM | |
|---|---|---|
| HIPAA Information Security and Privacy Requirements | Mapping | HPAs |
| Implement encryption and/or access controls, to prevent and detect | PA 01, 10, 22 | HPA 03 |
| unauthorized intrusions into the system and network. | | |
| Implement identification and authentication mechanisms for access to | PA 01, 11, 13 | HPA 03 |
| the system and network. | | |
| Ensure that sensitive information is altered or destroyed by | PA 01, 06, 11 | HPA 03 |
| authorized personnel only and that these activities are logged. | | |
| Establish means for message non-repudiation and authentication. | PA 01, 06, 11 | HPA 03 |
| Establish means to preserve integrity of messages or means to detect | PA 01, 06, 11 | HPA 03 |
| modification of a message. | | |
| Establish and implement log-on and log-off procedures to protect | PA 01, 08, 11 | HPA 03 |
| against unauthorized access to workstations and systems. | | |

TABLE 4

| | SSE-CMM | |
|---|---|---|
| HIPAA Information Security and Privacy Requirements | Mapping | HPAs |
| Develop policies and procedures for handling, storage and disposal of | PA 01,06 | HPA 05 |
| magnetic media and for object reuse. | | |
| Protect computer systems and related buildings and equipment from fire | PA 01, 02, 03, 04, | HPA 05 |
| and other hazards. | 05, 08, 11 | |
| Use physical controls to limit access to computer systems and facilities | PA 01, 03, 07, 11 | HPA 05 |
| to authorized personnel. | | |
| Physically secure workstations and laptops. | PA 01, 03, 11 | HPA 05 |

TABLE 5

| | SSE-CMM | |
|---|---|---|
| HIPAA Information Security and Privacy Requirements | Mapping | HPAs |
| Develop policies and procedures for handling, storage and disposal of | PA 01, 06 | HPA 05 |
| magnetic media and for object reuse. | | |
| Protect computer systems and related buildings and equipment from | PA 01, 02, 03, | HPA 05 |
| fire and other hazards. | 04, 05, 08, 11 | |
| Use physical controls to limit access to computer systems and facilities | PA 01, 03, 07, 11 | HPA 05 |
| to authorized personnel. | | |
| Physically secure workstations and laptops. | PA 01, 03, 11 | HPA 05 |

Conducting an appraisal using the mappings defined in the tables provides the means to measure the quality of the processes in place to meet the HIPAA information security-related regulation requirements. To provide meaningful results, the question of “What capability level ensures compliance?” has to be answered. The standard proposed in this approach is that for all the HIPAA-CMM PAs, the Level 2 GPs as defined in the SSE-CMM have to be achieved for minimum HIPAA information security-related compliance. For compliance to remain in place over the long term and be considered an element of continuous process improvement, the Level 3 GPs should be obtained.

As noted in Block 370 of FIG. 3, the appraisal results are used to implement continuous improvement of the information security processes.

A HIPAA-CMM and assessment methodology are developed herein as a standard for evaluating HIPAA compliance. With appropriate guidance from and use of the SSE-CMM PAs and the additional granularity and coverage of the HPAs defined herein, the HIPAA-CMM provides a formal, repeatable and consistent methodology through which an organization's HIPAA compliance can be assessed. This approach will identify areas of strong compliance, marginal compliance and lack of compliance and provide a consistent basis for defining remediation means. Inherently, the HIPAA-CMM also serves as a tool for implementing continuous improvement and evaluating the effectiveness of the improvement measures.

While the preferred embodiment and various alternative embodiments of the invention have been disclosed and described in detail herein, it will be apparent to those skilled in the art that various changes in form and detail may be made therein without departing from the spirit and scope thereof.

I claim as my invention:

1. A method of creating a healthcare information security and privacy processes capability maturity model comprising:
defining a set of healthcare information security requirements;
mapping SSE-CMM process areas to the defined healthcare security requirements set;
evaluating the mapping to determine which of the healthcare information security requirements are not covered or are incompletely covered; and,
mapping additional, healthcare information process areas to the healthcare information security requirements.

2. The method of claim 1, in which the healthcare information security and privacy requirements are based on the Healthcare Information Portability and Accountability Act.

3. The method of claim 1, wherein the healthcare information security and privacy requirements include base practices and general practices.

4. The method of claim 3, wherein the healthcare information process areas are comprised of a minimal number of process areas which are defined to cover all healthcare information security and privacy process areas and base practices not covered by the SSE-CMM process areas.

5. The method of claim 1, wherein the additional healthcare information process areas include HPA 01, HPA 02, HPA 03, HPA 04, and HPA 05.

6. A method of healthcare information security and privacy process evaluation, comprising:
obtaining evidence of how well current healthcare information security and privacy processes meet the standards set forth in a capability maturity model which is targeted at healthcare information security and privacy processes;
developing process maturity measurements based on the evidence;
evaluating the process maturity measurements to establish which processes do not meet at least Level 2 general practices;
designing improvements to current healthcare information security and privacy processes to allow the processes to meet at least Level 2 general practices; and,
repeating the method as necessary until all processes meet at least Level 2 general practices.

7. The method of claim 6, in which the capability maturity model is based on the Healthcare Information Portability and Accountability Act.

8. A method of creating a healthcare information security and privacy process capability maturity model and evaluating healthcare information processes comprising:
defining a set of healthcare information security and privacy requirements;
mapping SSE-CMM process areas to the defined healthcare security and privacy requirements set;
evaluating the mapping to determine which of the healthcare information security and privacy requirements are not covered or are incompletely covered;
mapping additional, healthcare information process areas to the healthcare information security and privacy requirements;
creating a healthcare information security and privacy process capability maturity model based on the process area mappings;
obtaining evidence of how well current healthcare information security and privacy processes meet the standards set forth in the capability maturity model;
developing process maturity measurements based on the evidence;
evaluating the process maturity measurements to establish which processes do not meet at least Level 2 general practices;
designing improvements to current healthcare information security and privacy processes to allow the processes to meet at least Level 2 general practices; and,
iteratively repeating the obtaining through designing steps as necessary until all processes meet at least Level 2 general practices.

9. The method of claim 8, in which the healthcare information security and privacy requirements are based on the Healthcare Information Portability and Accountability Act.

10. The method of claim 8, wherein the healthcare information security and privacy requirements include base practices and general practices.

11. The method of claim 10, wherein the healthcare information process areas are comprised of a minimal number of process areas which are defined to cover all healthcare information security and privacy process areas and base practices not covered by the SSE-CMM process areas.

12. The method of claim 8, wherein the additional healthcare information process areas include HPA 01, HPA 02, HPA 03, HPA 04, and HPA 05.
